(19) United States
(12) Patent Application Publication
(10) Pub. No.: US 2009/0187951 A1
(43) Pub. Date: Jul. 23, 2009

(54) SYSTEM FOR PREVENTING DUPLICATE RECORDINGS

(75) Inventors: Mary C. McCarthy, San Antonio, TX (US); Elizabeth Lopez, San Antonio, TX (US); Valerie H. Montalvo, San Antonio, TX (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/017,205

(22) Filed: Jan. 21, 2008

(51) Int. Cl. G06F 3/00

(52) U.S. Cl. 725/58

(57) ABSTRACT

Disclosed embodiments help prevent recording duplicate instances of multimedia programs on digital video recorders (DVRs). In response to a request to schedule the broadcast and recording of a multimedia event, a network-based scheduler pings a DVR to determine whether a duplicate instance of the requested multimedia program is stored on the DVR. In some cases, metadata associated with recorded programs on the DVR is analyzed and compared to metadata associated with the requested multimedia event. If an exact match, or a match that meets a threshold value, is determined by comparing the metadata, the scheduler may notify the user of the potential for storing the duplicate instance of the multimedia program. In some embodiments, the scheduler processes user requests to override the prevention of recording duplicates.

### BACKGROUND

1. Field of the Disclosure

The present disclosure generally relates to distribution of multimedia content and more particularly to systems and methods for preventing duplicate recordings.

2. Description of the Related Art

Digital video recorders (DVRs) may record multimedia content such as television programs. In the case of Internet protocol television (IPTV) systems, an automated scheduler may participate in approving requests to record and broadcasting the requested multimedia content.

### BRIEF DESCRIPTION OF THE DRAWINGS

FIG. 1 illustrates a representative IPTV system for implementing disclosed embodiments;

FIG. 2 illustrates a methodology for preventing duplicate multimedia products from being recorded in accordance with disclosed embodiments; and

FIG. 3 depicts a data processing system for use with disclosed embodiments.

### DESCRIPTION OF THE EMBODIMENT(S)

In one aspect, a method is disclosed for scheduling a DVR to record multimedia programs broadcast from a provider network. The method includes determining whether an instance of a multimedia program is stored on the DVR. If an instance of the multimedia program is not stored on the DVR, then the method includes scheduling the provider network to broadcast the multimedia program and scheduling the DVR to record the multimedia program during a predetermined interval. In some embodiments, the method includes retrieving first metadata associated with the multimedia program and comparing the first metadata to second metadata associated with stored multimedia programs. The first metadata may be retrieved by a network-based scheduler in accordance with some embodiments. Disclosed embodiments may employ a network-based scheduler for retrieving the second metadata from the DVR and comparing the first metadata to the second metadata. Additionally, the method may include determining whether the multimedia program is scheduled to record during the predetermined interval and determining whether the DVR has storage capacity to record the multimedia program. Further, the method may include notifying a user that the first metadata is within a tolerance value of the second metadata. In response to a user override, the method may further include scheduling the provider network to broadcast the multimedia program during the predetermined interval and scheduling the DVR to record the multimedia program during the predetermined interval.

In a further aspect, a computer program product is disclosed. The computer program product is stored on a machine readable medium and has instructions operable for determining whether an instance of a multimedia program is stored on the DVR. If an instance of the multimedia program is not stored on the DVR, then instructions are operable for scheduling the provider network to broadcast the multimedia program during a predetermined interval. Further instructions are operable for scheduling the DVR to record the multimedia program during the predetermined interval. In some embodiments, further instructions are operable for retrieving first metadata associated with the multimedia program and comparing the first metadata to second metadata associated with stored multimedia programs. In some embodiments, the first metadata is retrieved by a network-based scheduler. The network-based scheduler may be for retrieving the second metadata from the DVR and comparing the first metadata to the second metadata. In some embodiments, further instructions are operable for determining whether the multimedia program is scheduled to record during the predetermined interval and are operable for determining whether the DVR has storage capacity to record the multimedia program. Instructions may further be operable for notifying a user that the first metadata is within a tolerance value of the second metadata. Additionally, in response to a user override, further instructions may be operational for scheduling the provider network to broadcast the multimedia program during the predetermined interval and operational for scheduling the DVR to record the multimedia program during the predetermined interval.

In an additional aspect, a network-based scheduler is disclosed for preventing duplicate recordings of multimedia content. The scheduler is enabled to receive a request to record a requested multimedia program. The scheduler is further enabled to analyze the contents of a DVR storage to determine whether an instance of the requested multimedia program is contained in the storage. The scheduler is further enabled to schedule a broadcast of the multimedia program to the DVR during a predetermined interval if there is no instance of the requested multimedia program contained in the storage. In additional embodiments, the network-based scheduler is further enabled to prevent the broadcast of the multimedia program to the DVR in response to there being an instance of the requested multimedia program in the storage. The scheduler may be further enabled to provide a notification if there is an instance of the requested multimedia program contained in the storage. In response to an override request, the scheduler may be further enabled to schedule broadcasting of the requested multimedia program during the predetermined interval. In some embodiments, the storage contains a plurality of stored multimedia programs and analyzing the contents of the DVR includes comparing stored metadata associated with a portion of the stored multimedia programs to metadata associated with the requested multimedia program. Additionally, comparing stored metadata may include comparing titles of stored multimedia programs with a title of the requested multimedia program. For a portion of stored multimedia programs, analyzing the contents of the DVR may further include determining a level of similarity between each title of the stored multimedia programs and the title of the requested multimedia program and comparing the level of similarity to a threshold level.

In the following description, for the purposes of explanation, numerous specific details are set forth in order to provide a thorough understanding of the disclosed embodiments. A person of ordinary skill in the art should recognize that embodiments might be practiced without some of these specific details. In other instances, well-known structures and devices may be shown in block diagram form or omitted for clarity.

Television programs, movies, radio programming and other multimedia content may be distributed over telephone company networks, coaxial-based networks, satellite transmissions, WiFi transmission, WiMAX transmission, and the like. In some systems, for example traditional coaxial-based “cable” systems, a content provider may distribute through the same coaxial or fiber-optic cable a compound signal containing a number of television channels at different frequencies. In conjunction, a set-top box or a tuner within a television, radio, or recorder selects one or more channels from the compound signal to play or record. In contrast to such systems that simultaneously distribute every available channel at all times, IPTV systems generally distribute content only in response to user requests. Such IPTV systems typically use Internet Protocol (IP) and other technologies found in computer networks. To provide IPTV, a user's telephone lines may be used in some combination with a residential gateway (RG), a digital subscriber line (DSL) modem, a set-top box (STB), a display, and other such equipment to receive and convert into usable form the multimedia content provided from a telephone company network, for example.

Traditional broadcast services, for example some coaxial-based networks, transmit all available programs to all consumers on the network at all times. In switched digital broadcast system, television channels are transmitted to a consumer only when specifically requested by the consumer. In an illustrative embodiment, programs are broadcast from a content provider's transmission facility (i.e., “headend”) onto a local network only when requested by a consumer. Specifically, when a consumer selects a program for viewing through an interactive program guide (i.e., an electronic programming guide) an application determines whether the requested program is currently being broadcast on a local network. If so, the STB of the requesting consumer may tune into the local broadcast. If the program is not currently being sent to the local network, then the STB of the requesting consumer may request from a server application that it broadcast the requested content. Accordingly, switched broadcasting delivers to a consumer only the content that the consumer requests.

IPTV providers, satellite-based providers, digital cable providers, and others may distribute multimedia content using bidirectional (i.e., two-way) communication between a user's customer premises equipment (CPE) and the content provider's equipment. Bidirectional communication allows a content provider to offer advanced features, such as video-on-demand (VOD), pay-per-view, advanced programming information, text-based news, and the like.

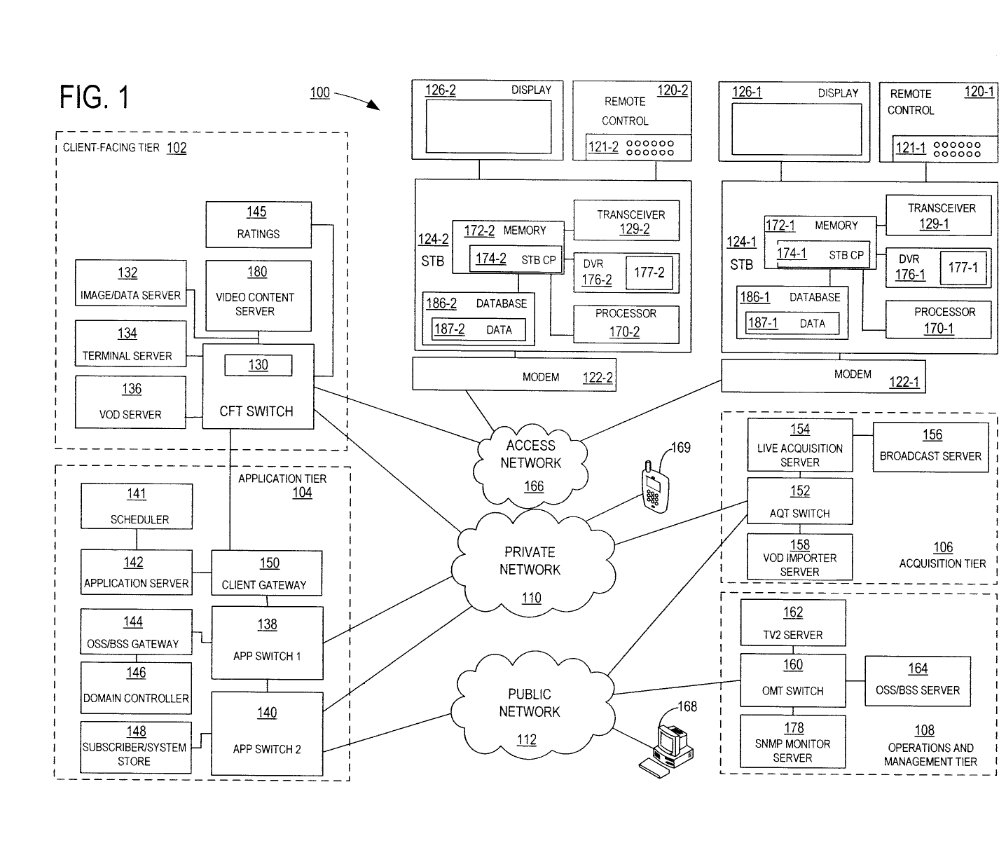

Referring now to the drawings, FIG. 1 illustrates selected aspects of an IPTV system 100 operated as part of a provider network. Throughout this disclosure, a hyphenated form of a reference numeral refers to a specific instance of an element and the un-hyphenated form of the reference numeral refers to the element generically or collectively. Thus, for example, reference numeral 124-1 refers to an instance of an element 124. As shown in FIG. 1, IPTV system 100 includes two STBs 124 including STB 124-1 and STB 124-2. In the depicted embodiment, STBs 124 communicate through access network 166 via modems 122 (i.e., modem 122-1 and modem 122-2).

As shown, IPTV system 100 is configured to provide multimedia content to users of STBs 124 and includes a client facing tier (CFT) 102, an application tier 104, an acquisition tier 106, and an operations and management tier 108. In addition, IPTV system 100 may provide multimedia content to personal computer (PC) 168 and mobile device 169, which may be a mobile telephone. Each tier 102, 104, 106 and 108 is coupled to a private network 110, to a public network 112 (e.g., the Internet), or to both the private network 110 and the public network 112. Any of the various tiers coupled to the various networks may communicate with each other over the networks. For example, as shown, the CFT 102 may communicate through the private network 110 with the acquisition tier 106. Further, as shown, the application tier 104 may communicate through the private network 110 and the public network 112 with the acquisition tier 106. The interconnections between illustrated tiers and networks in FIG. 1 are meant as instructive and not limiting.

As shown, IPTV system 100 distributes multimedia content to users of STBs 124 for viewing on displays 126 and possibly for sending to other components not shown, such as a portable media player. In order to distribute the multimedia content, IPTV system 100 must first gain access to the multimedia content. To that end, acquisition tier 106 represents a variety of systems to acquire multimedia content, reformat it when necessary, and prepare it for transmission over private network 110 or public network 112. In its capacity at acquiring and distributing multimedia for use on IPTV system 100, acquisition tier 106 serves as a “content headend.” Acquisition tier 106 may include, for example, systems for capturing analog and/or digital content feeds, either directly from a content provider or from a content aggregation facility. Content feeds transmitted via VHF/UHF broadcast signals may be captured by broadcast server 156. Similarly, live acquisition server 154 may capture satellite signals, high-speed fiber feeds, or programming feeds sent over other suitable transmission means. Content feeds to live acquisition server 154 may include broadcasted multimedia content, for example premium audio/video programming (i.e., traditional “cable channels”) widely available but not typically broadcast over airwaves. Acquisition tier 106 may further include signal conditioning systems and content preparation systems for encoding content. As shown, acquisition tier 106 includes VOD importer server 158 and may include a digital rights management (DRM) server for encrypting content (not shown). VOD importer server 158 receives content from one or more VOD sources that may be outside the IPTV system 100, for example discs or transmitted feeds. VOD importer server 158 may temporarily store multimedia content for transmission to a VOD server 136 on CFT 102. In addition, the VOD content may be stored at one or more servers, such as the VOD server 136. The stored VOD content may be distributed by multicast (i.e., a single stream sent simultaneously to multiple viewers) or by unicast to individual users in a VOD system.

After acquiring the multimedia content, IPTV system 100 distributes the content over private network 110, for example. Private network 110 may be referred to as a “core network.” In some embodiments, private network 110 consists of a fiber backbone (i.e., WAN) and one or more video hub offices (VHOs). Generally, private network 110 transports multimedia content (e.g., video, music, Web pages, channel lineups, and data) from the acquisition tier 106 to STBs 124 through access network 166 (via CFT switch 130). In this role, private network 110 serves as the “backbone” for IPTV system 100. In a large deployment of IPTV system 100 that covers a vast geographic region, private network 110 may represent several smaller networks that each may only transfer content within a subset of the region. Accordingly, private network 110 may provide for the insertion of local content that is relevant only to a subset region. For example, private network 110 may allow for the localized insertion of local advertisements or local emergency alert systems for a particular service area.

In an illustrative embodiment, real time ratings module 145 operates within CFT 102 to monitor in real time or substantially in real time the number of consumers viewing a particular channel, VOD program, pay-per-view event, television program, or other multimedia program or broadcast. As shown, real time ratings module 145 may be operatively coupled to CFT switch 130. In operation, real time ratings module 145, alone or in conjunction with CFT switch 130, may track multimedia content that is requested and viewed by consumers, for example users of STBs 124-1 and 124-2. To this end, traffic monitoring may be implemented, such as by conducting port-mirroring to monitor packets sent over access network 166 to STB 124-2 and STB 124-1, as examples. Alternatively, real time ratings module 145 may be communicatively coupled to some combination of video content server 180, image/data server 132, terminal server 134, and VOD server 136 to monitor traffic destined for consumers, for example users of STB 124-1 and STB 124-2. In this way, viewership data for a particular multimedia product may be registered and stored in real time or substantially in real time.

To illustrate the distribution of multimedia content acquired by acquisition tier 106, in an example embodiment, broadcast server 156 acquires broadcast multimedia content and communicates it to live acquisition server 154. Live acquisition server 154 transmits the multimedia content to the AcQuisition Tier (AQT) switch 152. In turn, the AQT switch 152 transmits the multimedia content to the CFT switch 130, for example, via the private network 110. As shown, the CFT switch 130 may communicate the multimedia content through modems 122 via the private access network 166. In some embodiments, STBs 124 receive the multimedia content via modems 122 and transmit it to displays 126.

In some embodiments, live acquisition server 154 and VOD importer server 158 take numerous data streams and encode them into a digital video format, such as MPEG-2, or MPEG-4. After encoding, data streams may be encapsulated into IP data streams and transmitted to specific IP destinations (e.g., STBs 124) in response to a user's request for a particular channel, for example. Video content server 180, VOD server 136, or image/data server 132 may act as an intermediary or repository for multimedia content obtained and encoded by acquisition tier 106. In some embodiments, multimedia content is transmitted to the video content server 180, where it is encoded, formatted, stored, or otherwise manipulated and prepared for communication to the STB 124.

As shown, IPTV system 100 includes access network 166. Access network 166 provides a network link from the private network 110 to each consumer's location. To this end, access network 166 provides a network translation as necessary from a switched network, for example, to the access technology used to transmit data and multimedia content to the consumer's location. For example, a content provider that uses twisted-pair telephone lines to deliver multimedia content to consumers may utilize DSL within access network 166. The DSL may utilize some combination of DSL, DSL2, DSL2+, ADSL, VDSL or other technologies. In some embodiments, access network 166 may use fiber-to-the-home (FTTH). In such cases, optical fiber may be used all the way to the consumer's location to provide high-bandwidth. In other embodiments, fiber-to-the-curb (FTTC) deployments are used to deliver multimedia content to consumers. In such cases, a DSL access multiplexer (DSLAM) may be used within access network 166 to transfer signals containing multimedia content from optical fiber to copper wire for DSL delivery to consumers. In other embodiments, access network 166 may use radio frequency (RF) signals sent over coaxial cables. Accordingly, access network 166 may utilize quadrature amplitude modulation (QAM) equipment for downstream traffic. In these systems, access network 166 may receive upstream traffic from a consumer's location using quadrature phase shift keying (QPSK) modulated RF signals. In such systems, a cable modem termination system (CMTS) may be used to mediate between IP-based traffic on private network 110 and access network 166.

In operation, if a user requests VOD content via a STB 124, the request may be transmitted over the access network 166 to VOD server 136, via the CFT switch 130. Upon receiving the request, the VOD server 136 retrieves or accesses the requested VOD content and transmits the content to the STB 124 across access network 166 via CFT switch 130. In turn, STB 124 transmits relevant video portions of the VOD content to the display 126. STB 124 may transmit audio portions of the VOD content to a stereo system (not shown) or may allow (or disallow) sending the VOD content to a recording device (not shown).

As shown, IPTV system 100 includes application tier 104. As shown, application tier 104 communicates with acquisition tier 106 and CFT 102 through private network 110. Application tier 104 may communicate through various communication protocols including hypertext transfer protocol (HTTP). Generally, application tier 104 may include notification servers, billing servers, and any of a variety of subscriber application servers employed by an owner or operator (i.e., network content provider) of IPTV system 100. In some embodiments, elements of the application tier 104 such as client gateway 150 communicate directly with the CFT 102. The components of CFT 102 may communicate using HTTP, transmission control protocol (TCP) or datagram protocol (UDP), as examples.

As illustrated in FIG. 1, the CFT 102 is coupled for communication with user equipment (e.g., modems 122) via access network 166. Access network 166 may be referred to as the “last mile” for a content provider or network operator. It provides network connectivity of IPTV services to consumers' locations. CFT 102 may be required to multicast multimedia content to multiple destinations. For example, the same multimedia content may be distributed substantially simultaneously to STB 124-1 and STB 124-2. In contrast to a multicast or a unicast, some embodiments “broadcast” programming or data to all users on a network as a “broadcast” transmission. For example, a TV guide feature for displaying available programming may be broadcast to every user. Regardless of whether multimedia content is distributed using a unicast, a multicast, or a broadcast, in accordance with disclosed embodiments, CFT 102 and its components may be configured to track viewership data and provide real time ratings to market researchers and other users. For example, real time ratings module 145 may host a web page or otherwise provide access to data by a user of PC 168. The user of PC 168 may monitor a graphical user interface (GUI) to determine the share of a particular television program that is then being displayed on displays 126-1 and 126-2. If the user of PC 168 is a multimedia content owner or producer responsible for the content available to displays 126, then having access to real time ratings may provide the user the opportunity to modify the content during the broadcast to increase the chances for higher viewership.

To deliver multimedia content, CFT 102 may employ any current or future IPs for providing reliable real-time streaming multimedia content. In addition to the TCP, UDP, and HTTP protocols discussed above, such protocols may use, in various combinations, other protocols including, file transfer protocol (FTP), real-time transport protocol (RTP), real-time control protocol (RTCP), and real-time streaming protocol (RTSP), as examples. In some embodiments, CFT 102 sends multimedia content encapsulated into IP packets over access network 166. For example, an MPEG-2 transport stream may be sent, in which the transport stream consists of a series of 188-byte transport packets, for example. To ensure quality of service, protocols should be chosen that minimize dropped packets, jitter, delay, data corruption, and other errors.

As shown, the CFT 102 may communicate with a large number of STBs, such as representative STBs 124, over a wide area, which may be for example, a regional area, a metropolitan area, a viewing area, a designated market area, or any other suitable geographic area, market area, or user group supported by networking the CFT 102 to numerous STBs. In an illustrative embodiment, the CFT 102, or any portion thereof, may be included at a video headend office (not depicted).

In some embodiments, the CFT 102 may be coupled to modems 122 via fiber optic cables. Alternatively, modems 122 may be DSL modems coupled to one or more network nodes via twisted pairs. Each STB 124 may process data received over the private access network 166 via various IPTV software platforms that are commonly known.

In an illustrative embodiment, the CFT 102 includes a CFT switch 130 that manages communication between the CFT 102 and access network 166. CFT switch 130 also manages communication between the CFT 102 and the private network 110 and is coupled to an image data server 132 that may store streaming multimedia content and possibly still images associated with programs of various IPTV channels. Image data server 132 stores data related to various channels, for example, types of data related to the channels and to programs or video content displayed via the channels. In an illustrative embodiment, image data server 132 may be a cluster of servers, each of which may store streaming multimedia content, still images, channel and program-related data, or any combination thereof. CFT switch 130 may also be coupled to terminal server 134 that provides terminal devices with a connection point to the private network 110. As shown, CFT switch 130 may also be coupled to VOD server 136 that stores or provides VOD content imported by the IPTV system 100. As shown, the CFT 102 also includes video content server 180 that transmits video content requested by viewers to STBs 124. In some embodiments, video content server 180 includes one or more multicast servers.

As illustrated in FIG. 1, application tier 104 may communicate with numerous components through private network 110 and public network 112. As shown, application tier 104 includes a first application tier (APP) switch 138 and a second APP switch 140. The first APP switch 138 is coupled to the second APP switch 140 and a combination operation-systems-support (OSS) and billing-systems-support (BSS) gateway 144 (i.e., OSS/BSS gateway 144). In some embodiments, the OSS/BSS gateway 144 controls access to an OSS/BSS server 164 that stores operations and billing systems data.

As shown, application tier 104 includes application server 142. Application server 142 may be any data processing system with associated software that provides information services (i.e., applications) for clients or users. Application server 142 may be optimized to provide services including conferencing, voicemail, and unified messaging. In some embodiments, services include EPGs, conditional access systems (CAS), DRM servers, a navigation/middleware server, and IPTV portal, e-mail services, and remote diagnostics.

Disclosed embodiments prevent duplicate recordings by enabling a DVR scheduler in a multimedia content distribution system (e.g., an IPTV system) to check the contents of a storage device (e.g., a hard drive in a DVR) to compare stored identification data of stored content with identification data of requested programs. The stored identification data is compared to the identification data of requested programs to determine whether the requested program is already recorded. Accordingly, disclosed systems promote easier navigation of menu systems related to stored content and help prevent a storage device from becoming full. In some embodiments, stored and requested programs have associated meta-data containing the title and series number for a program. A unique identification number may be assigned to each program. To determine whether a DVR has a requested program in storage, upon the user of the DVR requesting to schedule a recording, a program scheduler may send a software ping to the DVR hard drive to attempt matching the scheduled program's meta-data with that of any stored multimedia program on the hard drive. In some cases, a threshold value (e.g., an 80% match) is used when comparing stored program identifiers with the program identifiers of requested programs. If a threshold value is matched during the comparison, then the scheduled recording may be cancelled or otherwise prevented. In some embodiments, a user is provided notification of the potential for recording a duplicate multimedia program. The user may provide an override that causes the recording to occur. Therefore, disclosed embodiments promote having ample room for storing for upcoming multimedia programs without running out of storage space. In DVRs that delete the oldest programs to make room for new recordings, disclosed embodiments help prevent users from losing recorded programs so that a DVR can record a duplicate of another program.

As shown, in accordance with disclosed embodiments, scheduler 141 is communicatively coupled to application server 142 for preventing duplicate recordings of programs on DVRs 176. DVRs 176, as shown, are integrated into STBs 124. However, STBs 124 and DVRs 176 may be independent devices. On the other hand, the functionality and circuitry for STBs 124 and DVRs 176 may be integrated in televisions, PCs, or other appliances in accordance with disclosed embodiments.

As shown, DVRs 176 may have storage 177 for storing multimedia content (e.g., programs). Alternatively, DVRs 176 may be communicatively coupled to external storage or memory (e.g., memories 172) for storing multimedia programs. Program identifiers and metadata associated with stored multimedia programs associated with DVRs 176 may be stored on storage 177 or, alternatively, other storage such as databases 186. In accordance with disclosed embodiments, a user that is watching television on display 126-2 may view an EPG listing a variety of available multimedia programs (e.g., sporting events) that are available for recording. Using remote control buttons 121-2, the user may provide directional input to cause a cursor on display 126-2 to highlight a particular multimedia program from within the EPG. Upon selection, the highlighted multimedia program is designated as a requested multimedia program. As shown, STB 124-2 sends a request to scheduler 141 to request that, at the appropriate time (e.g., at a predetermined time) of the broadcast of the requested multimedia program and during a predetermined interval, STB 124-2 receive a broadcast of the requested multimedia program. Prior to scheduling the broadcast of the requested multimedia program, scheduler 141 pings storage 177-2 to determine whether the requested multimedia program is a stored multimedia program. Alternatively, scheduler 141 may ping database 186-2, to determine whether storage 177-2 already contains an instance of the requested multimedia program.

In some embodiments, stored multimedia programs are indexed using program identifiers such as unique numerical identifiers or by the title of a particular multimedia event. In some embodiments, scheduler 141 compares the titles of stored multimedia events with the titles of requested multimedia events to determine if a threshold value (e.g., 80% match) occurs. If so, scheduler 141 may prompt STB 124-2 to send a notification to a user over display 126-2, for example. Alternatively, notifications may be sent to users over mobile device 169 or PC 168. A user may be presented an opportunity using remote control 121-2 on remote control 120-2 to provide an override to allow the recording of a potential duplicate instance of a multimedia program. Alternatively, scheduler 141 may disallow or otherwise prevent the future broadcast of the requested multimedia program to STB 124-2. If scheduler 141 determines that a requested multimedia program is not already recorded on storage 177-2, then it schedules the broadcast of the requested program and verifies the broadcast and recording during a predetermined interval with DVR 176-2. In some embodiments, in the event of a change of schedule of a multimedia event, scheduler 141 may communicate with DVR 176-2 to ensure that the requested multimedia program is properly and completely recorded. In accordance with some disclosed embodiments, scheduler 141 is a computer program product stored on a computer readable medium with instructions operable for preventing multiple instances of a requested multimedia event from being broadcast to STB 124-2 and recorded on DVR 176-2. As shown, scheduler 141 is a network-based scheduler in that it is not resident on DVR 176-2 or STB 124-2. In addition, in accordance with some embodiments, requested multimedia programs are broadcast on an on-demand basis. In this sense, STB 124-2 does not receive every possible broadcast at all times simultaneously from access network 166, as is the case with some cable-based and air-based transmission systems. In some cases, access network 166 broadcasts a particular requested multimedia program to several STBs (e.g., STBs 124) at the same time. In other cases, access network 166 may unicast a requested multimedia program to a single STB (e.g., STB 124-2).

As shown in FIG. 1, second APP switch 140 is communicatively coupled to a domain controller 146 that provides web access, for example, to users via the public network 112. The second APP switch 140 is communicatively coupled to a subscriber/system store 148 that includes account information, such as account information that is associated with users who access the IPTV system 100 via the private network 110 or the public network 112. Therefore, for example, a user may employ a PC 168 to receive IPTV account information via the public network 112. Similarly, a user may employ mobile device 169 or another similar multifunction device over private network 110 or public network 112 to receive information through second APP switch 140. In some embodiments, application tier 104 may also include a client gateway 150 that communicates data directly with the CFT 102. In these embodiments, the client gateway 150 may be coupled directly to the CFT switch 130. Accordingly, the client gateway 150 may provide user access to the private network 110 and the tiers coupled thereto.

In some embodiments, STB 124 accesses the IPTV system 100 via the access network 166, using information received from the client gateway 150. In such embodiments, access network 166 may provide security for the private network 110. Therefore, user devices may access the client gateway 150 via the access network 166, and the client gateway 150 may allow such devices to access the private network 110 once the devices are authenticated or verified. Similarly, the client gateway 150 may prevent unauthorized devices, such as hacker computers or stolen STBs, from accessing the private network 110, by denying access to these devices beyond the access network 166.

Accordingly, in some embodiments, when an STB 124 accesses the IPTV system 100 via the access network 166, the client gateway 150 verifies user information by communicating with the subscriber/system store 148 via the private network 110, the first APP switch 138, and the second APP switch 140. The client gateway 150 verifies billing information and user status by communicating with the OSS/BSS gateway 144 via the private network 110 and the first APP switch 138. The OSS/BSS gateway 144 may transmit a query across the first APP switch 138, to the second APP switch 140, and the second APP switch 140 may communicate the query across the public network 112 to the OSS/BSS server 164. Upon the client gateway 150 confirming user and/or billing information, the client gateway 150 allows the STB 124 access to IPTV content, VOD content, and other services. If the client gateway 150 cannot verify user information for the STB 124, for example, because it is connected to an unauthorized twisted pair or RG, the client gateway 150 may block transmissions to and from the STB 124 beyond the access network 166.

STBs 124 convert digital compressed signals into a format suitable for display. STBs 124 have functionality for recognizing and acting on IP packets, for example UDPs transmitted within IP datagrams. STBs 124 may contain software or firmware coding for sending requests to application server 142, for example, to receive requested programming or data. In some embodiments, requests for content (e.g., VOD content) flow through a billing or management server to verify that a user is not in arrears regarding payment. In some embodiments, STB 124 supports Web browsing on the Internet (e.g., public network 112) and may support cycling through guide data, for example, using Web services. Each STB 124 may be enabled for viewing e-mail, viewing e-mail attachments, and interfacing with various types of home networks.

In accordance with disclosed embodiments, each STB 124 may be a cable box, a satellite box, or an EPG box. Further, although shown separately, STBs 124 may be incorporated into any multifunctional device such as, a television, a videocassette recorder, a DVR, a computer, a PC media player, or other media device. Generally, STBs 124 each represent a dedicated data processing system (e.g., computer) that provides an interface between a display and a content provider. As shown, STBs 124 are connected to the content provider through modems 122. Although modems are shown in FIG. 1, other RGs may be employed. Alternatively, STBs 124 may be connected directly to access network 166.

STBs 124 contain software or firmware instructions stored in memories 172 or other storage for receiving and processing input from remote controls 120. In some embodiments, STBs 124 are IP based STBs and have capability for outputting resultant multimedia signals (e.g., streaming audio/video) in various formats including S-video, composite video, high definition component video, high definition multimedia interface (HTMI), and video graphics array (VGA) signals. The resultant multimedia signals may support displays 126 that have various video modes including analog NTSC, 1080i, 1080p, 480i, 480p, 720p, as examples. In some embodiments, STBs 124 communicate with modems 122 over local area networks (LANs) connected using CAT5 cables, CAT6 cables, wireless interfaces, or a Home Phoneline Networking Alliance (HPNA) network, as examples.

As shown STBs 124 are coupled to displays 126. Each display 126 may include a cathode ray tube (CRT), television, monitor, projected image, liquid crystal display (LCD) screen, holograph, or other graphical equipment.

STBs 124 communicate with remote controls 120. STBs 124 may include wireless transceivers 129 to communicate with wireless transceivers (not shown) of remote controls 120. Although the term “buttons” may be used to describe some embodiments herein, other forms of input may be used. For example, touch screens associated with remote controls 120 may be used to accept user input. Alternatively, remote controls 120 may be used in conjunction with STBs 124 to operate GUIs displayed on displays 126.

STBs 124 may receive multimedia data including video content and audio content from the CFT 102 via the access network 166. The multimedia content may be associated with a broadcast program that includes streaming multimedia content. The multimedia content may include VOD presentations and pay-per-view sporting events. The multimedia content may include pod casts, web casts, or audio files used for playing on portable audio devices, as examples. As it receives data that includes the multimedia content, STB 124 may store the content or may format the content into a resultant multimedia signal for sending to displays 126 and other equipment (not shown) for producing portions of the multimedia content in usable form.

As shown, each STB 124 includes an STB processor 170 and an STB memory 172 that is accessible by STB processor 170. An STB computer program (STB CP) 174, as shown, is embedded within each STB memory 172. As shown, memories 172 are coupled with databases 186 that each include data 187. Data 187 may contain information regarding user preferences associated with STBs 124.

In addition to or in conjunction with STB components illustrated in FIG. 1, STBs 124 may contain modules for transport, de-multiplexing, audio/video encoding and decoding, audio digital to analog converting, and RF modulation. For clarity, such details for these modules are not shown in FIG. 1. In addition details are not provided for allowing STBs 124 to communicate through access network 166 through modems 122. However, such communications can be carried out with known protocols and systems for network interfacing such as conventional network interface cards (NICs) used in PC platforms. For example STB 124 may use a network interface that implements level 1 (physical) and level 2 (data link) layers of a standard communication protocol stack by enabling access to a twisted pair or other form of physical network medium and supporting low level addressing using media access control (MAC) addressing. In these embodiments, STBs 124 may each have a network interface including a globally unique 48-bit MAC address stored in a read-only memory (ROM) or other persistent storage element. Similarly, each modem 122 (or other RG) may have a network interface (not depicted) with its own globally unique MAC address. Further, although STBs 124 are depicted with various functions in separate components, these components may be implemented with a system on chip (SoC) device that integrates two or more components.

As shown, STBs 124 may also include a video content storage module, such as a DVR 176. In a particular embodiment, STBs 124 may communicate commands received from the remote control devices 120 to the CFT 102 via the private access network 166. Commands received from the remote control devices 120 may be entered via buttons 121.

IPTV system 100 includes an operations and management tier 108 that has an operations and management tier (OMT) switch 160. OMT switch 160 conducts communication between the operations and management tier 108 and the public network 112. The OMT switch 160 is coupled to a TV2 server 162. Additionally, the OMT switch 160 as shown is coupled to an OSS/BSS server 164 and to a simple network management protocol (SNMP) monitor server 178 that monitors network devices within or coupled to the IPTV system 100. In some embodiments, the OMT switch 160 communicates with the AQT switch 152 via the public network 112.

In an illustrative embodiment, the live acquisition server 154 transmits the multimedia content to the AQT switch 152, and the AQT switch 152, in turn, transmits the multimedia content to the OMT switch 160 via the public network 112. In turn, the OMT switch 160 transmits the multimedia content to the TV2 server 162 for display to users accessing the user interface at the TV2 server 162. For example, a user may access the TV2 server 162 using a PC 168 coupled to the public network 112.

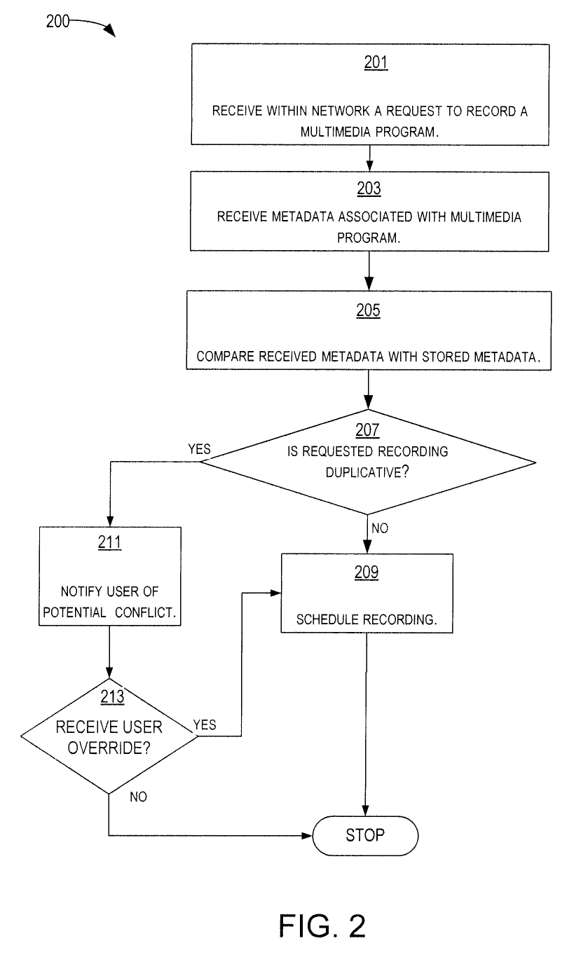

FIG. 2 illustrates representative operations of a methodology 200 for preventing duplicate recordings on a DVR. The IPTV system illustrated in FIG. 1 may be used to perform methodology 200. Operation 201 relates to receiving a request to record a multimedia program. Related to operation 201, a user may provide input (i.e., a request) through a GUI presented on a display using an STB. The GUI may include an EPG with a list of selectable program identifiers that represent available multimedia programs (e.g., VOD movie, pay-per-view sporting event, or television program). A user may provide a request to record a multimedia program by providing directional input to a remote control device to cause a cursor or graphical box on a display to highlight a selectable program identifier. After selecting the program identifier, the GUI may provide the user with a further selectable icon for recording the multimedia program. Alternatively, a user may highlight or select a program identifier on a GUI and provide directly a “record” request from a remote control device. In response to the user request to record a program, a network-based scheduler within a provider network receives the request to record the multimedia program, in accordance with operation 201.

Operation 203 relates to receiving metadata associated with the requested multimedia program. For example, scheduler 141 (FIG. 1) may store or access metadata associated with all available multimedia programs. In some embodiments, scheduler 141 may access VOD server 136 (FIG. 1) to receive metadata associated with VOD movies that have been requested (i.e., requested multimedia programs). Similarly, in some embodiments, scheduler 141 may access TV2 server 162 (FIG. 1) or broadcast server 156 (FIG. 1) for metadata associated with requested multimedia programs. In operation 205, metadata received in operation 203 is compared to stored metadata for multimedia programs that have already been recorded, for example, on a DVR associated with the user making the request to record. For the IPTV system 100 (FIG. 1), operation 205 may relate to scheduler 141 accessing (i.e., receiving) metadata for a requested VOD movie (i.e., a multimedia program) from VOD server 136. Scheduler 141 compares the received metadata to stored metadata associated with DVR 176-2, for example. In some embodiments, multimedia programs have unique identifiers and a received identifier for a particular requested multimedia program is compared to the stored identifier for each multimedia program stored on DVR 176-2 (FIG. 1). If there is an exact match for the identifier received from the VOD server 136 and any of the stored identifiers on DVR 176-2, in optional operation 211 a user is notified of a potential conflict. Optional operation 213 allows a user to provide an override to record what may be a duplicate recording. If, in operation 213, a user does not provide an override after receiving an indication in operation 211 of the potential conflict, methodology 200 is stopped. However, if in operation 213 a user provides an override, in operation 209 the potentially duplicative recording is scheduled. As shown, if in operation 207 the comparison operation results in a determination that a requested recording is not potentially duplicative, then methodology 200 proceeds to operation 209 for scheduling the recording of the requested multimedia program. In some embodiments, in operation 205 the stored metadata is associated with scheduled recordings and operation 205 relates to determining whether a requested multimedia program has already been requested for recording.

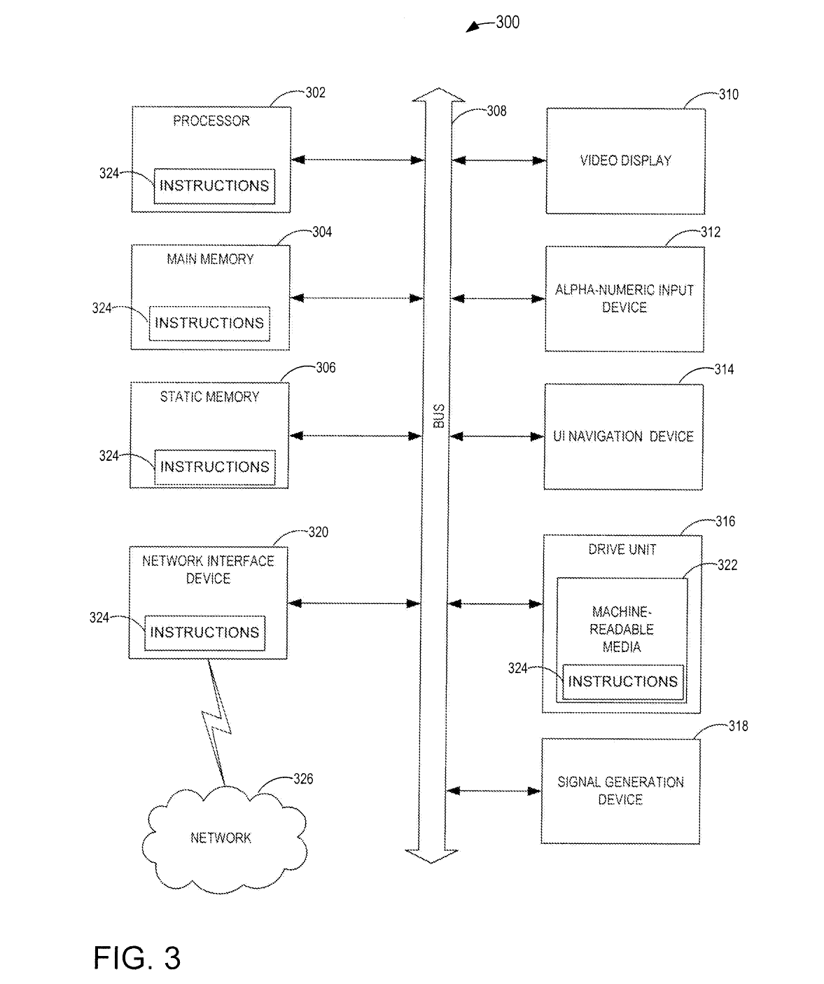

FIG. 3 illustrates in block diagram form a data processing system 300 within which a set of instructions may operate to perform one or more of the methodologies discussed herein. Data processing system 300 may operate as a standalone device or may be connected (e.g., networked) to other data processing systems. In a networked deployment, data processing system 300 may operate in the capacity of a server or a client data processing system in a server-client network environment, or as a peer computer in a peer-to-peer (or distributed) network environment. Example data processing systems include, but are not limited to a DVR, a PC, a tablet PC, STB, a cable box, a satellite box, an EPG box, a personal digital assistant (PDA), a cellular telephone, a smart phone, a web appliance, a network router, a switch, a bridge, a server, or any machine capable of executing a set of instructions (sequential or otherwise) that specify actions to be taken by that machine. Further, while only a single data processing system is illustrated, the term “data processing system” shall also be taken to include any collection of data processing systems that individually or jointly execute a set (or multiple sets) of instructions to perform any one or more of the methodologies discussed herein.

As shown, data processing system 300 includes a processor 302 (e.g., a central processing unit, a graphics processing unit, or both), a main memory 304, and a static memory 306 that may communicate with each other via a bus 308. In some embodiments, the main memory 304 and/or the static memory 306 may be used to store the indicators or values that relate to multimedia content accessed or requested by a consumer. Data processing system 300 may further include a video display unit 310 (e.g., a television, an LCD or a CRT) on which to display multimedia content such as pay-per-view sporting events, television programs, VOD movies, and the like. Data processing system 300 also includes an alphanumeric input device 312 (e.g., a keyboard or a remote control), a user interface (UI) navigation device 314 (e.g., a remote control or a mouse), a disk drive unit 316, a signal generation device 318 (e.g., a speaker) and a network interface device 320. The input device 312 and/or the UI navigation device 314 (e.g., the remote control) may include a processor (not shown), and a memory (not shown). The disk drive unit 316 includes a machine-readable medium 322 that may have stored thereon one or more sets of instructions and data structures (e.g., instructions 324) embodying or utilized by any one or more of the methodologies or functions described herein. The instructions 324 may also reside, completely or at least partially, within the main memory 304, within static memory 306, within network interface device 320, and/or within the processor 302 during execution thereof by the data processing system 300.

The instructions 324 may further be transmitted or received over a network 326 (e.g., a content provider) via the network interface device 320 utilizing any of a number of transfer protocols (e.g., broadcast transmissions, HTTP). While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine (i.e., data processing system) and that cause the machine to perform any one or more of the methodologies of the present disclosure, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the disclosed systems may be described in connection with one or more embodiments, it is not intended to limit the subject matter of the claims to the particular forms set forth. On the contrary, it is intended to cover such alternatives, modifications and equivalents as may be included within the spirit and scope of the subject matter as defined by the appended claims.

What is claimed is:

1. A method of scheduling a digital video recorder (DVR) to record multimedia programs broadcast from a provider network, the method comprising:
determining whether an instance of a multimedia program is stored on the DVR;
if an instance of the multimedia program is not stored on the DVR, then:
scheduling the provider network to start broadcasting the multimedia program at a predetermined start time, and
scheduling the DVR to record the multimedia program beginning at or near the predetermined time.

2. The method of claim 1, further comprising:
retrieving first metadata associated with the multimedia program; and
comparing the first metadata to second metadata associated with stored multimedia programs.

3. The method of claim 2, wherein the first metadata is retrieved by a network-based scheduler.

4. The method of claim 3, wherein the network-based scheduler is for retrieving the second metadata from the DVR and comparing the first metadata to the second metadata.

5. The method of claim 2, further comprising:
determining whether the multimedia program is scheduled to record during a predetermined interval that includes the predetermined start time.

6. The method of claim 5, further comprising:
determining whether the DVR has storage capacity to record the multimedia program.

7. The method of claim 6, further comprising:
notifying a user that the first metadata is within a tolerance value of the second metadata.

8. The method of claim 7, wherein in response to a user override, the method further comprises:
scheduling the provider network to broadcast the multimedia program during the predetermined interval, and
scheduling the DVR to record the multimedia program during the predetermined interval.

9. A computer program product stored on one or more computer readable media, the computer program for recording multimedia programs, the computer program including instructions operable for:
determining whether an instance of a multimedia program is stored on the digital video recorder (DVR);
if an instance of the multimedia program is not stored on the DVR, then:
scheduling the provider network to broadcast the multimedia program during a predetermined interval, and
scheduling the DVR to record the multimedia program during the predetermined interval.

10. The computer program product of claim 9, further comprising instructions operable for:
retrieving first metadata associated with the multimedia program; and
comparing the first metadata to second metadata associated with stored multimedia programs.

11. The computer program product of claim 10, wherein the first metadata is retrieved by a network-based scheduler.

12. The computer program product of claim 11, wherein the network-based scheduler is for retrieving the second metadata from the DVR and comparing the first metadata to the second metadata.

13. The computer program product of claim 10, further comprising instructions operable for:
determining whether the multimedia program is scheduled to record during the predetermined interval.

14. The computer program product of claim 13, further comprising instructions operable for:
determining whether the DVR has storage capacity to record the multimedia program.

15. The computer program product of claim 14, further comprising instructions operable for:
notifying a user that the first metadata is within a tolerance value of the second metadata.

16. The computer program product of claim 15, further comprising instructions operable for:
in response to a user override, scheduling the provider network to broadcast the multimedia program during the predetermined interval, and scheduling the DVR to record the multimedia program during the predetermined interval.

17. A network-based scheduler for preventing duplicate recordings of multimedia programs, the scheduler enabled to:
receive a request to record a requested multimedia program;
analyze the contents of a digital video recorder (DVR) storage to determine whether an instance of the requested multimedia program is contained in the storage; and
schedule a broadcast of the multimedia program to the DVR during a predetermined interval if there is no instance of the requested multimedia program contained in the storage.

18. The network-based scheduler of claim 17, wherein the scheduler is further enabled to prevent the broadcast of the multimedia program to the DVR in response to there being an instance of the requested multimedia program in the storage.

19. The network-based scheduler of claim 18, wherein the scheduler is further enabled to provide a notification if there is an instance of the requested multimedia program contained in the storage.

20. The network-based scheduler of claim 17, wherein in response to an override request, the scheduler is further enabled to:
schedule broadcasting of the requested multimedia program during the predetermined interval.

21. The network-based scheduler of claim 17, wherein the storage contains a plurality of stored multimedia programs, wherein analyzing the contents of the DVR includes comparing stored metadata associated with a portion of the stored multimedia programs to metadata associated with the requested multimedia program.

22. The network-based scheduler of claim 21, wherein comparing stored metadata includes comparing titles of stored multimedia programs with a title of the requested multimedia program.

23. The network-based scheduler of claim 22, wherein analyzing the contents of the DVR includes:
for a portion of stored multimedia programs, determining a level of similarity between each title of the stored multimedia programs and the title of the requested multimedia program; and
comparing the level of similarity to a threshold level.

24. The network-based scheduler of claim 17, wherein the scheduled broadcast is a unicast.
